(19) United States
(12) Patent Application Publication
(10) Pub. No.: US 2024/0148108 A1
(43) Pub. Date: May 9, 2024

(54) STROBEL FOR AN ARTICLE OF FOOTWEAR, AN ARTICLE OF FOOTWEAR AND PROCESS FOR MANUFACTURING THE ARTICLE OF FOOTWEAR

(71) Applicant: BASF SE, Ludwigshafen am Rhein (DE)

(72) Inventors: Kai LIU, Guangzhou, Guangdong (CN); Zhi Hui Liu, Guangzhou, Guangdong (CN); Wahju Ardianto, Bangkok (TH); Yoke Khim Raymond Toh, Singapore (SG)

(73) Assignee: BASF SE, Ludwigshafen am Rhein (DE)

(21) Appl. No.: 18/549,724

(22) PCT Filed: Mar. 8, 2022
(86) PCT No.: PCT/EP2022/055927

§ 371 Date: Sep. 8, 2023

(30) Foreign Application Priority Data
Mar. 12, 2021 (WO) PCT/CN2021/080489

(51) Int. Cl. A43B 13/38; A43B 13/04; A43B 17/00; A43B 17/14; A43D 86/00; C08J 9/00; C08J 9/35

(52) U.S. Cl. CPC A43B 13/38; A43B 13/04; A43B 17/003; A43B 17/14; A43D 86/00; C08J 9/0061; C08J 9/35; C08J 2375/04; C08J 2375/08; C08J 2475/08

(57) ABSTRACT

A strobel for an article of footwear contains ETPU. The article of footwear and a process for manufacturing the article f footwear are also provided.

### TECHNICAL FIELD

The invention relates to footwear and more particularly to a strobel for an article of footwear, an article of footwear comprising the strobel and also the process for manufacturing the article of footwear.

### BACKGROUND ART

There is an ever-increasing demand on the comfort performance of footwear, especially footwear intended for use in particular applications, such as sports and safety shoes, military shoes, boots, fashion shoes, etc. It is thus of great interest for footwear industries to develop shoes that meet high technical specifications for cushioning and energy return, while still being light weight and highly durable.

Footwear construction commonly includes a strobel board, which is disposed at the bottom of the upper for closing the upper. The strobel enables lasting of the upper and maintains the shape of the upper; ideally the strobel does not stretch and distort appreciably. In order to achieve the abovementioned function, it often requires rigidity and may be made of typically textiles (non-wovens, wovens, knit) or papers. All of these materials have shortcoming of poor cushioning. Such being the case, further layer(s), manufactured from soft foam, may be laminated or cemented to the proximal surface of the strobel to provide certain cushioning and comfort.

US 2016/0302517 A1 discloses a sole assembly having an outsole and a midsole disposed below a strobel board, and also a topsole and an inner sole disposed above the strobel board; wherein the strobel board was made of non-wovens, wovens or knit.

WO 2020/112301 A1 describes a strobel of a relatively inelastic material provided with through holes, which could have overcome the negative effect of strobel on the cushioning and compression characteristics of an underlying sole structure.

WO 2019231882 A1 discloses a strobel with two layers, the first of which is made of a relatively soft textile and the second is made of materials that inhibit a flowable polymeric material from penetrating the second layer.

In the preparation of footwear, the strobel is usually stitched to the upper. However, it is difficult to achieve a strong stitching between strobel made of foams and the upper, since the foam strobel usually has an insufficient strength to undergo the threading forces of the stitching line. For the above reasons, foams generally may not be used as materials for strobel.

Furthermore, in the prior art, the existing strobel (which is made of typically non-wovens, wovens, knit or papers) is often cemented to the outsole using adhesives, which requires an undesirable adhesion step in the preparation process of the footwear and is environmentally unfriendly.

In conclusion, all the above-mentioned prior arts have a disadvantage of multiple layers for the shoe sole, which increase the complexity of the preparation process and also increase the weight of the shoes; besides, the stiff strobel board decreases the comfort of the footwear.

### SUMMARY OF THE INVENTION

The present invention provides a strobel for an article of footwear, wherein the strobel comprises ETPU.

The present invention further provides a strobel for an article of footwear, wherein the strobel comprises a hybrid material of ETPU and a PU foam matrix.

The present invention further provides an article of footwear comprising the strobel as defined in the above.

The present invention further provides a process of manufacturing an article of footwear, comprising:
i) stitching an upper to the strobel as defined in the above; and/or
ii) hot-pressing the strobel as defined in the above to an outsole.

The above aspects and other aspects of the present application are readily apparent from the following detailed description of the modes for carrying out the present teachings.

### DESCRIPTION OF THE DRAWINGS

FIG. 1 shows an embodiment of the strobel according to the invention which comprises ETPU.

FIG. 2 shows an embodiment of the strobel according to the invention which comprises a hybrid material of ETPU and a PU foam matrix.

### DETAILED DESCRIPTION OF THE INVENTION

The present invention provides a strobel for an article of footwear, wherein the strobel comprises ETPU or a hybrid material of ETPU and a PU foam matrix.

The strobel for an article of footwear may define any configurations. For example, the strobel consists of one layer of ETPU or a hybrid material of ETPU and a PU foam matrix. More preferably, the strobel comprises one layer of ETPU or a hybrid material of ETPU and a PU foam matrix, and one layer of thin textile provided on the proximal surface of the hybrid material layer.

As used herein, the abbreviation “ETPU” refers to expanded thermoplastic polyurethane.

As used herein, the abbreviation “PU” refers to polyurethane.

Strobel Comprising ETPU

The present invention provides a strobel for an article of footwear, wherein the strobel comprises ETPU.

Thermoplastic polyurethane (TPU) is prepared, for example, by reacting isocyanates with compounds which are reactive toward isocyanates and have a molecular weight of from 500 to 10 000 g/mol and, if appropriate, chain extenders having a molecular weight of from 50 to 499 g/mol, if appropriate in the presence of catalysts and/or customary auxiliaries and/or additives, such as blowing agent. Then, the expanded thermoplastic polyurethanes (ETPU) are preferably obtained by expansion of the above-mentioned thermoplastic polyurethane particles, for example when the TPU pellets are depressurized at temperatures above the softening temperature of the TPU in suspension process.

It is preferable that the ETPU is based on thermoplastic polyurethane produced by using polyester polyalcohol, polyether polyalcohol, more preferably polytetrahydrofuran. In an embodiment, the polytetrahydrofuran used has a molecular weight of from 600 to 2500 g/mol, preferably 800-2000 g/mol, more preferably 1000-1800 g/mol. In another embodiment, a polyester polyalcohol with molecular weight of from 500 to 2500 g/mol, preferably from 600 to 900 g/mol, is used to produce the ETPU. In an embodiment, the polyester polyalcohol is preferably polyester diol, preferably one based on adipic acid and 1,4-butanediol, having a number average molecular weight of from 500 to 2500 g/mol, particularly preferably from 600 g/mol to 900 g/mol.

Other detailed information for ETPU is described, for example, in patent applications US 20100047550 A1 or WO2007/082838, which are incorporated herein to an extent that they do not conflict with the disclosure of the present application.

The strobel comprising ETPU may be produced by steamchest molding process or by heat press process, wherein these processes themselves are known by those skilled in the art.

In an embodiment of the steamchest molding process, the ETPU beads are charged into a proper-size strobel-shape mold, and then steamchest molded by introducing a steam with a temperatures of, for example 100° C. to 140° C., preferably 110° C. to 130° C.; with the proviso that the specific ETPU beads optionally further expand, and fuse to one another to give a molding ETPU foam of strobel.

In an embodiment of the heat press process, the ETPU beads fuse to one another in a closed mold with exposure to heat at a temperature of, for example, 100° C. to 140° C., preferably 110° C. to 130° C. For this, the mold is filled with the beads, then closed, and supplied with steam or hot air. Then, the ETPU beads optionally further expand, and fuse to one another to give a molding ETPU foam. The foam may be semifinished product, for example sheet, profile, or finished molding with simple or complicated geometry and the strobel is obtained by cutting the molding foam to a strobel-shape.

In an embodiment, the molding ETPU foam (i.e., the material directly used as the strobe)) has a density of 50-500 kg/m³, preferably 70-400 kg/m³, more preferably 100-300 kg/m³, and most preferably 150-260 kg/m³, and even more preferably 200-250 kg/m³.

Herein, the ETPU bead is preferably spherical, elliptical, triangle or polygonal, or any other regular or irregular geometries. In an embodiment, ETPU has an average particle size of from 1 mm to 12 mm, preferably from 2 mm to 10 mm, more preferably from 3 mm to 8 mm, and even more preferably 3 mm to 7 mm. Herein, an average particle size refers to an average diameter of the ETPU; in the case of non-spherical particles, for example elliptical particles, the diameter refers to the longest axis of the ETPU bead.

In an embodiment, the molding ETPU foam has a hardness of 25-50 AskerC, preferably 25-45 AskerC, and more preferably 28-40 AskerC, measured according to JIS K 7312.

In an embodiment, the molding ETPU foam has a rebound resilience of 50-80%, preferably 53-75%, more preferably 55-70%, even more preferably 58-65%, measured according to DIN 53 512:2000.

In a preferred embodiment, ETPU is commercially available from BASF SE, for example under the tradename of Infinergy™. Other detailed information for Infinergy™ is described, for example, in patent application US 20100047550 A1, which is incorporated herein to an extent that it does not conflict with the disclosure of the present application.

Strobel Comprising Hybrid Material of ETPU and a PU Foam Matrix

The present invention further provides a strobel for an article of footwear, wherein the strobel comprises a hybrid material of ETPU and a PU foam matrix.

It is preferable that ETPU present in the hybrid material is as defined in the above.

In an embodiment, the PU foam matrix has a density of 50-600 kg/m³, preferably 80-500 kg/m³, more preferably 100-400 kg/m³, even more preferably 150-300 kg/m³.

Herein, the PU foam matrix has cells of any shapes, preferably spherical, elliptical, triangle or polygonal, or any other regular or irregular geometries.

In an embodiment, the hybrid material has a density of 50-600 kg/m³, preferably 100-500 kg/m³, more preferably 150-400 kg/m³, even more preferably 200-300 kg/m³.

In an embodiment, the hybrid material has a hardness of 25-50 AskerC, preferably 25-45 AskerC, and more preferably 30-43 AskerC, measured according to JIS K 7312.

In an embodiment, the hybrid material has a rebound resilience of 30-80%, preferably 40-70%, more preferably 45-65%, and even more preferably 50-65%, measured according to DIN 53 512:2000.

In an embodiment of the invention, the strobel comprising a hybrid material of ETPU and a PU foam matrix is produced by mixing (a) polyisocyanates with (b) compounds having hydrogenatoms which are reactive toward isocyanates, (c) expanded thermoplastic polyurethane (ETPU) particles and, if appropriate, (d) chain extenders and/or crosslinkers, (e) catalysts, (f) blowing agents and (g) further additives, and reacting the mixture in a mold to form the strobel comprising the hybrid material.

It is preferable component (c) is as defined in the above.

Components (a), (b) and (d)-(g) have the same meanings as defined in the patent application US 20100047550 A1, which is incorporated herein to an extent that it does not conflict with the disclosure of the present application.

The organic and/or modified polyisocyanates (a) used to produce the polyurethane (PU) of the invention comprise the aliphatic, cycloaliphatic, and aromatic di- or poly-functional isocyanates known from the prior art (constituent a-1), and also any desired mixtures thereof. Examples are diphenylmethane 4,4′-diisocyanate, diphenylmethane 2,4′-diisocyanate, the mixtures of monomeric diphenylmethane diisocyanates with diphenylmethane-diisocyanate homologs having a relatively large number of rings (polymer-MDI), tetramethylene diisocyanate, hexamethylene diisocyanate (HDI), isophorone diisocyanate (IPDI), tolylene 2,4- or 2,6-diisocyanate (TDI), and mixtures of the isocyanates mentioned.

It is preferable to use 4,4′-MDI. The 4,4′-MDI preferably used can comprise from 0 to 20 wt. % of 2,4′-MDI and small amounts, up to about 10 wt. %, of allophanate- or uretonimine-modified polyisocyanates. It is also possible to use small amounts of polyphenylene polymethylene polyisocyanate (polymeric MDI). The total amount of these high-functionality polyisocyanates should not exceed 5 wt. % of the isocyanate used.

Polyisocyanate component (a) is preferably used in the form of polyisocyanate prepolymers. These polyisocyanate prepolymers are obtainable by reacting polyisocyanates (a-1) described above with polyols (a-2) to give the prepolymer, for example at temperatures of from 30 to 100° C., preferably at about 80° C. Preference is given to 4,4′-MDI together with uretonimine-modified MDI and commercial polyols based on polyesters, for example ones derived from adipic acid or polyethers, for example ones derived from ethylene oxide and/or propylene oxide, for producing the prepolymers employed according to the invention.

Polyols (a-2) are known to those skilled in the art and are described by way of example in “Kunststoffhandbuch [Plastics handbook], Volume 7, Polyurethane [Polyurethanes]”, Carl Hanser Verlag, 3rd Edition 1993, chapter 3.1.

Prepolymers based on ethers are preferably obtained by reacting polyisocyanates (a-1), particularly preferably 4,4′-MDI, with 2- to 3-functional polyoxypropylene polyols and/or polyoxypropylene-polyoxyethylene polyols. They are usually prepared by the generally known base-catalyzed addition of propylene oxide alone or in admixture with ethylene oxide onto H-functional, in particular OH-functional, starter substances. Starter substances employed are, for example, water, ethylene glycol or propylene glycol and also glycerol or trimethylolpropane. Furthermore, multimetal cyanide compounds, known as DMC catalysts, can also be used as catalysts. For example, polyethers as described below under (b) can be used as component (a-2).

When ethylene oxide/propylene oxide mixtures are used, the ethylene oxide is preferably used in an amount of 10-50 wt. %, based on the total amount of alkylene oxide. The alkylene oxides can be incorporated blockwise or as a random mixture. Particular preference is given to incorporation of an ethylene oxide end block (“EO cap”) in order to increase the content of more reactive primary OH end groups. The number average molecular weight of the polyols (a-2) is preferably in the range from 1750 to 5500 g/mol.

If appropriate, customary chain extenders or crosslinkers are added to the polyols mentioned in the preparation of the isocyanate prepolymers. Such substances are described below under c). Particular preference is given to using dipropylene glycol, tripropylene glycol or monoethylene glycol (MEG) as chain extenders or crosslinkers.

In an embodiment, polyisocyanate component (a), preferably in the form of prepolymer, is used in an amount of from 30 to 50 wt. %, preferably from 35 to 45 wt. %, and in particular from 38 to 42 wt. %, based on the weight of components (a), (b) and (d)-(g).

Relatively high molecular weight component (b) having at least two H atoms which are reactive toward isocyanate is used. Suitable component (b) may be selected from polyols, including polyetherols, polyesterols or mixtures thereof.

Polyetherols are prepared by known processes, for example via anionic polymerization using, as catalysts, alkali metal hydroxides or alkali metal alcoholates, and with addition of at least one starter molecule which comprises from 2 to 3 reactive hydrogen atoms, or via cationic polymerization using Lewis acids, such as antimony pentachloride or boron fluoride etherate, from one or more alkylene oxides having from 2 to 4 carbon atoms in the alkylene radical. Examples of suitable alkylene oxides are tetrahydrofuran, propylene 1,3-oxide, butylene 1,2-oxide, butylene 2,3-oxide, and preferably ethylene oxide and propylene 1,2-oxide. Other catalysts that can be used are multimetal cyanide compounds, known as DMC catalysts. The alkylene oxides can be used individually, in alternating succession, or in the form of a mixture. It is preferable to use mixtures composed of propylene 1,2-oxide and ethylene oxide, where the amounts of ethylene oxide used as ethylene oxide end block (EO cap) are from 10 to 50%, giving the resultant polyols more than 70% of primary OH end groups.

The starter molecule used can comprise water or di- and tri-hydric alcohols, such as ethylene glycol, 1,2- and 1,3-propanediol, diethylene glycol, dipropylene glycol, 1,4-butanediol, glycerol, or trimethylolpropane.

The polyether polyols, preferably polyoxypropylene-polyoxyethylene polyols, have a functionality of from 2 to 3 and a molecular weight of from 1000 to 8000 g/mol, preferably from 2000 to 6000 g/mol.

It is also preferable to use polyetherols obtained by ring-opening polymerization of tetrahydrofuran. These polytetrahydrofurans preferably have a functionality of about 2 and have a number average molecular weight in the range from 500 to 4000 g/mol, preferably in the range from 700 to 3000 g/mol and more preferably in the range from 900 to 2500 g/mol. Polytetrahydrofuran (PTHF) is also known in the pertinent art under the designations tetramethylene glycol (PTMG), polytetramethylene glycol ether (PTMEG) or polytetramethylene oxides (PTMO).

By way of example, polyester polyols can be prepared from organic dicarboxylic acids having from 2 to 12 carbon atoms, preferably from aliphatic dicarboxylic acids having from 4 to 6 carbon atoms, and from polyhydric alcohols, preferably diols, having from 2 to 12 carbon atoms, preferably from 2 to 6 carbon atoms. Examples of dicarboxylic acids that can be used are: succinic acid, glutaric acid, adipic acid, suberic acid, azelaic acid, sebacic acid, decanedicarboxylic acid, maleic acid, fumaric acid, phthalic acid, isophthalic acid, and terephthalic acid. The dicarboxylic acids here can be used either individually or else in a mixture with one another. Instead of the free dicarboxylic acids, it is also possible to use the corresponding dicarboxylic acid derivatives, e.g. dicarboxylic esters of alcohols having from 1 to 4 carbon atoms, or dicarboxylic anhydrides. It is preferable to use dicarboxylic acid mixtures composed of succinic, glutaric, and adipic acid in quantitative proportions of, for example, 20-35: 35-50: 20-32 parts by weight, and in particular adipic acid. Examples of di- and polyhydric alcohols, in particular diols, are: ethanediol, diethylene glycol, 1,2- or 1,3-propanediol, dipropylene glycol, 1,4-butanediol, 1,5-pentanediol, 1,6-hexanediol, 1,10-decanediol, glycerol, and trimethylolpropane. It is preferable to use ethanediol, diethylene glycol, 1,4-butanediol, 1,5-pentanediol, and 1,6-hexanediol. It is also possible to use polyester polyols derived from lactones, e.g. caprolactone, or hydroxycarboxylic acids, e.g. hydroxycaproic acid.

For preparation of the polyester polyols, the organic, e.g. aromatic, and preferably aliphatic, polycarboxylic acids and/or their derivatives and polyhydric alcohols can be polycondensed without a catalyst or preferably in the presence of esterification catalysts, advantageously in an atmosphere composed of inert gas, for example nitrogen, carbon monoxide, helium, argon, etc., in the melt at temperatures which are from 150 to 250° C., preferably from 180 to 220° C., if appropriate at reduced pressure, until the desired acid number has been reached, this preferably being smaller than 10, particularly preferably smaller than 2. According to one preferred embodiment, the esterification mixture is polycondensed at the abovementioned temperatures until the acid number is from 80 to 30, preferably from 40 to 30, at atmospheric pressure, and then at a pressure which is smaller than 500 mbar, preferably from 50 to 150 mbar. Examples of esterification catalysts that can be used are iron catalysts, cadmium catalysts, cobalt catalysts, lead catalysts, zinc catalysts, antimony catalysts, magnesium catalysts, titanium catalysts, and tin catalysts, in the form of metals, of metal oxides, or of metal salts. However, the polycondensation process can also be carried out in a liquid phase in the presence of diluents and/or entrainers, e.g. benzene, toluene, xylene, or chlorobenzene, for the azeotropic removal of the water of condensation by distillation. The polyester polyols are advantageously produced by polycondensing the organic polycarboxylic acids and/or polycarboxylic acid derivatives and polyhydric alcohols in a molar ratio of 1:1 to 1.8, preferably 1:1.05 to 1.2.

The resultant polyester polyols preferably have a functionality of from 2 to 4, in particular from 2 to 3, and a molecular weight of from 480 to 3000 g/mol, preferably from 1000 to 3000 g/mol.

Mixtures comprising polyetherols and polyesterols are also suitable component (b).

Other suitable polyols are polymer-modified polyols, preferably polymer-modified polyesterols or polyetherols, particularly preferably graft polyetherols or graft polyesterols, in particular graft polyetherols. These are what is known as a polymer polyol, usually having from 5 to 60 wt. %, preferably from 10 to 55 wt. %, particularly preferably from 30 to 55 wt. %, and in particular from to 50 wt. %, content of preferably thermoplastic polymers. These polymer polyesterols are described by way of example in WO 05/098763 and EP-A 250 351, and are usually prepared via free-radical polymerization of suitable olefinic monomers, such as styrene, acrylonitrile, (meth)acrylates, (meth)acrylic acid, and/or acrylamide, in a polyesterol serving as graft base. The side chains are generally produced via transfer of the free radicals from growing polymer chains to polyesterols or polyetherols. The polymer polyol comprises, alongside the graft copolymer, mainly the homopolymers of the olefins, dispersed in unaltered polyesterol or polyetherol.

In one preferred embodiment, the monomers used comprise acrylonitrile, styrene, or acrylonitrite and styrene, particularly preferably exclusively styrene. The monomers are, if appropriate, polymerized in the presence of further monomers, of a macromer, and of a moderator, and with use of a free-radical initiator, mostly azo compounds or peroxide compounds, in a polyesterol or polyetherol as continuous phase. This process is described by way of example in DE 111 394, U.S. Pat. Nos. 3,304,273, 3,383,351, 3,523,093, DE 1 152 536, and DE 1 152 537.

In an embodiment, component (b) of suitable polyols are used in an amount of from 35 to 75 wt. %, preferably from 40 to 70 wt. %, and more preferably from 45 to 65 wt. %, and in particular from 50 to 60 wt. %, based on the weight of components (a), (b) and (d)-(g).

The hybrid materials of the invention can be produced with or without concomitant use of (d) chain extenders and/or crosslinking agents. However, addition of chain extenders, crosslinking agents or, if appropriate, else a mixture thereof can prove advantageous for modification of mechanical properties, e.g. of hardness. These chain extenders and/or crosslinking agents are substances with a molar mass which is preferably smaller than 400 g/mol, particularly preferably from 60 to 400 g/mol, and chain extenders here have 2 hydrogen atoms reactive toward isocyanates while crosslinking agents have 3 hydrogen atoms reactive toward isocyanate. These can be used individually or in the form of a mixture. It is preferable to use diols and/or triols with molecular weights smaller than 400, particularly preferably from 60 to 300, and more particularly from 60 to 150. Examples of those that can be used are aliphatic, cycloaliphatic, and/or araliphatic diols having from 2 to 14, preferably from 2 to 10, carbon atoms, e.g. monoethylene glycol, 1,2-propanediol, 1,3-propanediol, 1,3-butanediol, 1,10-decanediol, o-, m-, or p-dihydroxycyclohexane, diethylene glycol, dipropylene glycol, and preferably 1,4-butanediol, 1,6-hexanediol, and bis(2-hydroxyethyl)hydroquinone, triols, such as 1,2,4- or 1,3,5-trihydroxycyclohexane, glycerol, and trimethylolpropane, and low-molecular-weight polyalkylene oxides which comprise hydroxy groups and are based on ethylene oxide and/or on propylene 1,2-oxide and the abovementioned diols and/or triols as starter molecules.

If chain extenders, crosslinking agents, or a mixture of these are used, their amounts advantageously used are from 1 to 60 wt. %, preferably from 1.5 to 50 wt. %, and in particular from 2 to 40 wt. %, based on the weight of components (b) and (d).

If catalysts (e) are used for producing the hybrid materials of the invention, it is preferable to use compounds which markedly accelerate the reaction of the compounds of component (b) and, if appropriate, (d) comprising hydroxy groups with the organic, if appropriate modified, polyisocyanates (a). Examples that may be mentioned are amidines, such as 2,3-dimethyl-3,4,5,6-tetrahydropyrimidine, tertiary amines, such as triethylamine, tributylamine, dimethylbenzylamine, N-methyl-, N-ethyl-, or N-cyclohexylmorpholine, N,N,N′,N′-tetramethylethylenediamine, N, N, N′,N′-tetramethylbutanediamine, N, N, N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1 azabicyclo[3.3.0]octane, and preferably 1,4-diazabicyclo[2.2.2]octane, and alkanolamine compounds, such as triethanolamine, triisopropanolamine, N-methyl- and N ethyldiethanolamine, and dimethylethanolamine. Organometallic compounds can also be used, preferably organotin compounds, such as stannous salts of organic carboxylic acids, e.g. stannous acetate, stannous octoate, stannous ethylhexoate, and stannous laurate, and the dialkyltin(IV) salts of organic carboxylic acids, e.g. dibutyltin diacetate, dibutyltin dilaurate, dibutyltin maleate, and dioctyltin diacetate, and also bismuth carboxylates, such as bismuth(III) neodecanoate, bismuth 2-ethylhexanoate, and bismuth octanoate, or a mixture thereof. The organometallic compounds can be used alone or preferably in combination with strongly basic amines. If component (b) involves an ester, it is preferable to use exclusively amine catalysts.

It is preferable to use from 0.001 to 5 wt. %, in particular from 0.05 to 3 wt. %, of catalyst or catalyst combination, based on the weight of components (b) and (e).

Blowing agents (f) are also present as matrix material during the production of polyurethane foams. These blowing agents comprise water where appropriate. Blowing agents (f) that can be used are not only water but also well-known compounds having chemical and/or physical action. Chemical blowing agents are compounds which form gaseous products via reaction with isocyanate, an example being formic acid. Physical blowing agents are compounds which have been dissolved or emulsified within the starting materials for polyurethane production and which vaporize under the conditions of polyurethane formation. By way of example, these are hydrocarbons, halogenated hydrocarbons, and other compounds, e.g. perfluorinated alkanes, such as perfluorohexane, fluorochlorocarbons, and ethers, esters, ketones, and/or acetals, examples being (cyclo)aliphatic hydrocarbons having from 4 to 8 carbon atoms, or fluorocarbons, such as Solkane® 365 mfc. In one preferred embodiment, the blowing agent used comprises a mixture of said blowing agents, comprising water, and in particular is water as sole blowing agent. If no water is used as blowing agent, it is preferable to use exclusively physical blowing agents.

The content of water as blowing agent in one preferred embodiment is from 0.1 to 2 wt. %, preferably from 0.2 to 1.5 wt. %, particularly preferably from 0.3 to 1.2 wt. %, more particularly from 0.4 to 1 wt. %, based on the total weight of components (b) and (f).

Auxiliaries and/or additives (g) can, if appropriate, also be added to the reaction mixture for production of the hybrid materials of the invention. Examples that may be mentioned are surfactants, foam stabilizers, cell regulators, release agents, fillers, dyes, pigments, hydrolysis stabilizers, odor-absorbent substances, and fungistatic and bacteriostatic substances.

The inorganic and organic fillers can be used individually or in the form of a mixture, and the amounts of these advantageously added to the reaction mixture are from 0.5 to 50 wt. %, preferably from 1 to 40 wt. %, based on the weight of components (a), (b) and (d)-(g), where the content of matts, nonwovens, and textiles made of natural and synthetic fibers can, however, reach values up to 55 wt. %.

In an embodiment, ETPU is present in an amount of 0.1-99 wt. %, preferably 30-90 wt. %, more preferably 40-80 wt. %, and even more preferably 45-60 wt. %, based on the total weight of the hybrid material.

Other substance suitable for using as component (b) is water. It is known to those skilled in the art that water may also be regarded as substance having hydrogen atom which is reactive toward isocyanates, thus making it possible to act as component (b) in the production of polyurethane. In the case of water being used as component (b), additional blowing agents are not necessary.

In the embodiments comprising water as component (b), components (a), (c)-(e) and (g) are the same as described in the above in terms of the material type. In other words, components (a), (c)-(e) and (g) as described in the embodiments comprising polyol as component (b) also apply to the embodiments comprising water as component (b).

However, the embodiments comprising water as component (b) define different amounts of components (a)-(e) and (g) from the embodiments comprising polyol as component (b). In an embodiment, component (b) of water is used in an amount of from 0.5 to 5 wt. %, preferably from 0.8 to 4 wt. %, more preferably from 1 to 3 wt. %, based on the weight of components (a)(b), (d)-(e) and (g). In an embodiment, component (a) is used in an amount of from 30-99 wt. %, preferably from 35-98 wt. %, more preferably from 45-97.5 wt. %, based on the weight of components (a)-(b), (d)-(e) and (g). If component (d) is used, the amount advantageously used is from 1 to 5 wt. %, preferably from 2 to 4 wt. %, based on the weight of components (a)-(b), (d)-(e) and (g). In an embodiment, It is preferable to use from 0.05 to 5 wt. %, preferably from 0.1 to 4 wt. %, in particular from 1 to 3 wt. %, of catalyst or catalyst combination, based on the weight of components (a)-(b), (d)-(e) and (g).

In the embodiments comprising water as component (b), auxiliaries and/or additives (g) can, if present, be used individually or in the form of a mixture, and the amounts of these advantageously added to the reaction mixture are from 0.5 to 50 wt. %, preferably from 1 to 40 wt. %, based on the weight of components (a)-(b), (d)-(e) and (g), where the content of matts, nonwovens, and textiles made of natural and synthetic fibers can, however, reach values up to 55 wt. %.

In an embodiment comprising water as component (b), ETPU is present in an amount of 0.1-99 wt. %, preferably 40-98 wt. %, and more preferably 60-95 wt. %, based on the total weight of the hybrid material.

Furthermore, conductive particle may be added as a filler to the ETPU and/or PU foam matrix, in order to give a strobel with a good antistatic property. In an embodiment, the ETPU and a hybrid of ETPU and a PU foam matrix with conductive particles have relatively good electrostatic discharge (ESD) properties. In an embodiment, the ETPU and a hybrid of ETPU and a PU foam matrix with conductive particles have comparable ESD properties with paper strobel. In an embodiment, the ETPU and a hybrid of ETPU and a PU foam matrix with conductive particles have a resistivity of >10⁷ Ω·m, preferably >10⁸ Ω·m, more preferably from 5×10⁸ Ω·m to 5×10¹⁰ Ω·m, and even more preferably from 5×10⁸ Ω·m to 2×10¹⁰ Ω·m.

The foams of hybrid material are preferably produced by the one-shot process by means of the low-pressure or high-pressure technique in closed, advantageously heated molds. The molds usually comprise metal, e.g. aluminum or steel. These methods are described, for example, by Piechota and Röhr in “Integralschaumstoff, Carl-Hanser-Verlag, Munich, Vienna, 1975, or in the Kunststoff-Handbuch, Volume 7, Polyurethane, 3rd Edition, 1993, chapter 7.

The starting components are for this purpose mixed at a temperature of from 15° C. to 90° C., preferably from 20° C. to 45° C., more preferably from 30° C. to 40° C., and introduced into the closed mold, if appropriate under superatmospheric pressure, wherein the starting components include but are not limited to components (a)-(g). Mixing can be carried out mechanically by means of a stirrer or a stirring screw or under high pressure in the countercurrent injection process. The mold temperature is advantageously from 20° C. to 90° C., preferably from 30° C. to 60° C.

In the context of the present application, the term “proximal surface” refers to the surface of the strobel board, outsole, insole (also referred to as “inner sole”, “footbed” or “sockliner”) or any other layers that faces to the wear's foot when a wearer wears a shoe comprising the abovementioned layers. Accordingly, the term “distal surface” refers to the surface of the strobel board, outsole, insole or any other layers that faces to the ground. For the purpose of the invention, everything within the rear portion of the strobel is termed the heel region, and everything within the frontal portion of the strobel is termed the front region. The heel region preferably means the rear third of the strobel, and the front region preferably means the frontal third of the strobel, in each case based on the length of the strobel; and the remaining middle third of the strobel is termed the midfoot region.

In the present invention, the strobel may have any shapes or configurations. The following embodiments are described to facilitate the understanding of the present invention, without any attempt to limit the scope thereof.

In an embodiment, for example, the strobel is ergonomically designed; in other word, it has a shape and configuration as commonly used in the footwear engineering field. In an embodiment, for example, the strobel has a relatively uniform thickness in the intermediate region and similar thickness in the periphery region. In another embodiment, the strobel has a relatively uniform thickness in the intermediate region, and a thinner thickness in the periphery region. In another embodiment, the strobel has a gradually increased thickness from forefoot to heel.

In yet another embodiment, the strobel has a forefoot region, a midfoot region, and a heel region, in which the strobel may define one or more thicker forefoot region(s) in the forefoot region and/or one or more thicker heel region(s) in the heel region on the distal surface. The thicker region may be provided with any shape and size.

In the case of an integrally uniform thickness, the thickness is 1-100 mm, preferably 5-50 mm, more preferably 10-30 mm, and even more preferably 10-25 mm.

When the strobel has a relatively uniform thickness in the intermediate region and a thinner thickness in the periphery region, the thickness in the intermediate region is 1-100 mm, preferably 5-50 mm, more preferably 10-30 mm, even more preferably 10-25 mm, and the thickness in the periphery region is 1-100 mm, preferably 5-50 mm, more preferably 10-30 mm, and even more preferably 10-25 mm. In an embodiment, the strobel may have a gradually increased thickness from the intermediate region to the periphery region, rather than form a fault between the intermediate region and the periphery region.

When the strobel has a gradually increased thickness from forefoot to heel, the strobel has a thickness of 1-100 mm, preferably 5-50 mm, more preferably 10-30 mm, and even more preferably 10-25 mm in the forefoot region, and a thickness of 2-100 mm, preferably 5-50 mm, more preferably 10-30 mm, even more preferably 10-25 mm in the heel region.

In the present invention, the strobel is optionally provided with a thin textile layer on the proximal surface of the strobel. The thin textile layer may be selected from woven, non-woven, fabric. The thin textile layer may have a thickness of 0.1 mm to 10 mm, preferably 0.5 mm to 4 mm, more preferably 1 mm to 3 mm. In an embodiment, the layer of thin textile provides the strobel with an anti-static property. In another embodiment, the layer of thin textile is provided to enhance the appearances of the strobel. In yet another embodiment, the layer of thin textile may be dispensed.

The present invention further provides an article of footwear, including a strobel as defined in the above. The present invention further provides an article of footwear, including a strobel comprising ETPU or a hybrid material of ETPU and a PU foam matrix.

In an embodiment, the article of footwear includes the strobel as defined in the above, an upper and an outsole. In an embodiment, the article of footwear comprises the strobel as defined in the above, an upper bottomed with the strobel, and an outsole disposed below the strobel.

In an embodiment of the article of footwear, the article of footwear comprises a strobel and an outsole in the shoe sole, and optionally any other possible layers. In an embodiment, the shoe sole assembly of the article of footwear consists of a strobel, an insole and an outsole. In another embodiment, the shoe sole assembly of the article of footwear consists of a strobel and an outsole. Herein, a shoe sole assembly means all the parts that constitute a shoe sole. Herein, an insole has a general meaning as understood by those skilled in the art, which often is positioned with the foot-receiving cavity in the upper above the strobel board.

In an embodiment, the article of footwear is prepared by stitching the upper to the strobel. In an embodiment, the article of footwear is prepared by hot pressing the strobel to the outsole.

In the context of the present application, the outsole is made of any materials commonly used in the prior art, such as ethylene vinyl acetate (EVA), polyurethane (PU) or suitable rubbers. In an embodiment, the outsole is made of TPU.

In an embodiment, the strobel is processed to form a relatively thin periphery, and then the upper is stitched to the thin periphery of the strobel. In an embodiment of the present invention, the strobel has a shape of thin periphery, and the stitching may be achieved by threading the stitching line through the thin periphery. In an embodiment, the strobel has a thickness in the periphery region of 0.5-15 mm, preferably 2-10 mm, more preferably 2-5 mm.

In another embodiment, the upper is stitched to the strobel by slotting the periphery of the strobel and stitching the upper to the strobel at the slotted periphery. In an embodiment of the present invention, the strobel has relatively thick periphery region, and thus the strobel is cut open in the thickness direction to have a slot with certain depth. In an embodiment, the strobel has a thickness in the periphery region of 0.1-60 mm, preferably 0.2-50 mm, more preferably 1-40 mm, even more preferably 1-30 mm and in particularly 2-15 mm. In an embodiment, the slot is distant in thickness direction from the proximal surface of the strobel by 0.1-10 mm, preferably 0.2-8 mm, more preferably 0.5-5 mm.

In the context, the stitching process itself is well known to those skilled in the art. In the context, the hot press process itself is well known to those skilled in the art. Furthermore, the hot press process is carried out before or after stitching the strobel to the upper.

In an embodiment, the hot press process is performed at any temperatures suitable for the materials used. In an embodiment, the hot press process is performed at a temperature of 100-200° C., preferably 120-190° C., more preferably 150-180° C., for about 0.5 min to 3 min, preferably 50 s to 2 min, more preferably 1 min to 1.5 min.

In all embodiments, the article of footwear of the present invention possesses good properties in terms of cushioning and energy return, while still being light weight and highly durable.

The present invention further provides a process of manufacturing an article of footwear, comprising
i) stitching an upper to one of the strobels as defined in the above; and/or
ii) hot-pressing one of the strobels as defined in the above to an outsole.

In the present invention, step i) may be achieved by
i-1) processing the strobel to form a relatively thin periphery and stitching the upper to the strobel at the thin periphery, or
i-2) slotting the periphery of the strobel and stitching the strobel to the upper at the slotted periphery.

In an embodiment, the processing step of i-1) is preferably performed in such a mold that the desired shape is directly obtained during the preparation of ETPU or the hybrid material of ETPU and a PU foam matrix. In another embodiment, the processing step of i-1) is performed by mechanically processing the strobel according to the invention to form the thin periphery.

The process of manufacturing an article of footwear further comprises a step of hot-pressing the strobel to the outsole.

The stitching, slotting and hot-pressing processes may have the same meaning as defined in the above.

In the present application, the order of step i) and ii) is interchangeable in the order. In other word, despite the description in the above-mentioned sequence, step ii) may be performed before or after step i).

The present application is embodied in the following embodiments, with the preferred features being described in the dependent embodiments. However, these embodiments are described to facilitate the understanding of the present invention, without any attempt to limit the scope thereof.
1. A strobel for an article of footwear, wherein the strobel comprises ETPU.
2. The strobel according to embodiment 1, wherein the strobel comprises a hybrid material of ETPU and a PU foam matrix.
3. The strobel according to embodiment 1, wherein the strobel has a density of 50-500 kg/m³, preferably 70-400 kg/m³, more preferably 100-300 kg/m³, even more preferably 150-260 kg/m³, and most preferably 200-250 kg/m³.
4. The strobel according to embodiment 1, wherein the strobel has a hardness of 25-50 AskerC, preferably 25-45 AskerC, and more preferably 28-40 AskerC, measured according to JIS K 7312.
5. The strobel according to embodiment 1, wherein the strobel has a rebound resilience of 50-80%, preferably 53-75%, more preferably 55-70%, even more preferably 58-65%, measured according to DIN 53 512:2000.
6. The strobel according to embodiment 1 or 2, wherein the ETPU has an average particle size of from 1 mm to 12 mm, preferably from 2 mm to 10 mm, more preferably from 3 mm to 8 mm, and even more preferably 3 mm to 7 mm.
7. The strobel according to embodiment 2, wherein the PU foam matrix has a density of 50-600 kg/m³, preferably 80-500 kg/m³, more preferably 100-400 kg/m³, even more preferably 150-300 kg/m³.
8. The strobel according to embodiment 2, wherein the hybrid material has a density of 50-600 kg/m³, preferably 100-500 kg/m³, more preferably 150-400 kg/m³, even more preferably 200-300 kg/m³.
9. The strobel according to embodiment 2, wherein the hybrid material has a hardness of 25-50 AskerC, preferably 25-45 AskerC, and more preferably 30-43 AskerC, measured according to JIS K 7312.
10. The strobel according to embodiment 2, wherein the hybrid material has a rebound resilience of 30-80%, preferably 40-70%, more preferably 45-65%, even more preferably 50-65%, measured according to DIN 53 512:2000.
11. The strobel according to embodiment 2, wherein the strobel is produced by mixing
   (a) polyisocyanates, with
   (b) compounds having hydrogen atoms which are reactive toward isocyanates,
   (c) ETPU particles and, if appropriate,
   (d) chain extenders and/or crosslinkers,
   (e) catalysts,
   (f) blowing agents and
   (g) further additives; and
   reacting the mixture in a mold to form the strobel comprising the hybrid material.
12. The strobel according to embodiment 11, wherein component (b) is selected from polyether polyol, polyester polyol or mixtures thereof.
13. The strobel according to embodiment 11, wherein component (b) is water.
14. The strobel according to embodiment 12, wherein the ETPU is present in an amount of 0.1-99 wt. %, preferably 30-90 wt. %, more preferably 40-80 wt. %, and even more preferably 45-60 wt. %, based on the total weight of the hybrid material.
15. The strobel according to embodiment 13, wherein the ETPU is present in an amount of 0.1-99 wt. %, preferably 40-98 wt. %, and more preferably 60-95 wt. %, based on the total weight of the hybrid material.
16. An article of footwear, comprising a strobel as defined in any one of embodiments 1-15.
17. The article of footwear according to embodiment 16, wherein the article of footwear comprises:
   the strobel as defined in any one of embodiments 1-15;
   an upper bottomed with the strobel; and
   an outsole disposed below the strobel.
18. A process of manufacturing an article of footwear, comprising:
   i) stitching an upper to the strobel as defined in any one of embodiments 1-15; and/or
   ii) hot-pressing the strobel as defined in any one of embodiments 1-15 to an outsole.
19. The process as defined in embodiment 18, wherein the step i) comprises
   i-1) processing the strobel to form a relatively thin periphery and stitching the upper to the strobel at the thin periphery, or
   i-2) slotting the periphery of the strobel and stitching the strobel to the upper at the slotted periphery.
20. The process as defined in embodiment 18 or 19, wherein the outsole is made of EVA, PU or suitable rubbers.

The present application will be illustrated in detail by the following examples.

### Examples

Manufacture of Strobel

Materials:

ETPU1 used was commercially available from BASF SE under the tradename of Infinergy™ which has a bulk density of 200 kg/m³ and has an average particle size of 3 mm.

ETPU2 used was commercially available from BASF SE under the tradename of Infinergy™ which has a bulk density of 200 kg/m³ and has an average particle size of 7 mm. Before use, all ETPU beads were dried in an oven at about 55° C. for about 30 min.

PU Foam Matrix

Prepolymer component:
Prep 1 having an NCO content of 5% is prepared by reacting MDI with PO/EO based polyether polyol, defined as polyol 1 in the following.
Prep 2 having an NCO content of 19% is prepared by reacting MDI with PO/EO based polyether polyol, defined as polyol 2 in the following.

Compounds having hydrogen atoms which are reactive toward isocyanates:
polyol 1: PO/EO based polyether polyol, number average molecular weight=5000, OH=35;
polyol 2: PO/EO based polyether polyol, number average molecular weight=4000, OH=28;
polyol 3: Graft polyetherol, number average molecular weight=5000, OH=25; and water.
Catalyst 1: Dabco EG
Catalyst 2: Dabco BL-11
Catalyst 3: Dabco SE
Catalyst 4: Dabco 1027
Chain extender: monoethylene glycol (MEG)
Surfactant: Dabco DC193
Blowing agent: water

Test standard:
Hardness: JIS K 7312
Rebound resilience: DIN 53512:2000
Stitching: SATRA TM5

The formulation of the PU foam matrix according to the invention is listed in table 1.

TABLE 1
formulation of the PU foam matrix (% by weight)

| | PU1 | PU2 |
|---|---|---|
| polyol 1 | / | 17.5% |
| polyol 2 | / | 17.5% |
| polyol 3 | / | 19% |
| Water | 1% | / |
| Chain extender | / | 0.5% |
| Catalyst 1 | 0.9% | / |
| Catalyst 2 | 1.0% | / |
| Catalyst 3 | / | 0.8% |
| Catalyst 4 | / | / |
| Surfactant | 0.1% | 0.1% |
| Blowing agent | / | 0.8% |
| Prep 1 | 97% | / |
| Prep 2 | / | 43.8% |

Manufacturing Process of the Strobel:

1. Manufacturing Process of the Strobel with Pure ETPU:

Example 1-1 was produced using ETPU1 by steamchest molding process, wherein the process was performed at a temperature of about 110° C. Example 1-2 and Example 1-3 were produced by similar process as described for Example 1-1.

2. Manufacturing Process of the Strobel with a Hybrid Material of ETPU and a PU Foam Matrix:

### Example 2-1

1) A steel mold with centrifugal machine was used. The mold temperature was about 50° C.
2) Firstly, the ETPU beads were put into the container of low-pressure machine, and the PU raw materials were kept in the working temperature of about 55° C. When starting work, the ETPU beads and PU raw materials were pushed into the mixing head by screw and pump. Then all of them were poured into the steel mold. Then the PU started foaming and was covered with ETPU. After 2.5-4 min, the steel mold was opened to obtain the final strobel.

Examples 2-2, 2-3, 3-1, 3-2 and 3-3 were produced by similar process as described for Exampies 2-1. Comparative example 1 was produced using wood paper, and has a thickness of 10 mm.

All the final strobel products were tested in terms of the density, hardness (AskerC), and rebound resilience properties. The results are listed in Table 2.

TABLE 2
preparation of different strobels and the mechanical properties of the same

| | | | | | | | | | | CEx 1 |
|---|---|---|---|---|---|---|---|---|---|---|
| | Ex 1-1 | Ex 1-2 | Ex 1-3 | Ex 2-1 | Ex 2-2 | Ex 2-3 | Ex 3-1 | Ex 3-2 | Ex 3-3 | (paper) |
| ETPU1 | 100 | 100 | | 70 | | | 50 | 50 | | |
| ETPU2 | | | 100 | | 70 | 70 | | | 50 | |
| PU1 | | | | 30 | 30 | 30 | | | | |
| PU2 | | | | | | | 50 | 50 | 50 | |
| Thickness | 4-6 | 15-20 | 15-20 | 4-6 | 4-6 | 15-20 | 4-6 | 15-20 | 15-20 | 10 |
| (mm) | | | | | | | | | | |
| Density | 250 | 250 | 230 | 270 | 265 | 265 | 268 | 268 | 263 | 100 |
| (Kg/m3) | | | | | | | | | | |
| Hardness | 38 | 39 | 39 | 40 | 40 | 39 | 41 | 41 | 40 | 75 |
| (AskerC) | | | | | | | | | | |
| Rebound | 58 | 59 | 60 | 59 | 60 | 61 | 60 | 61 | 61 | 10 |
| (%) | | | | | | | | | | |

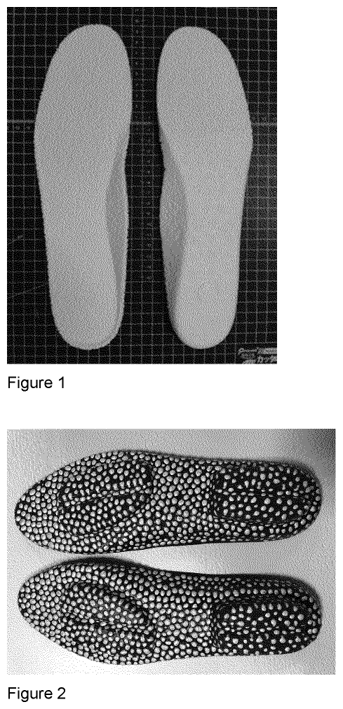

In table 2, the strobel has an ergonomically designed shape, which means a relatively thick portion in heel region and a relatively thin portion in the front region. The detailed shape refers to FIGS. 1 and 2. In table 2, the thickness is measured according to the thickness of the main part of the strobel. For instance, example 1-1 having a thickness of 4 to 6 mm refers to that the strobel has an average thickness of about 6 mm in heel region and of about 4 mm in front region.

The strobels were subjected to a stitch-tear strength test to determine their ability to hold stitches according to SATRA TM5.

Comparative examples 2 and 3 were produced using PU foam and EVA foam, respectively.
EVA foam density: 100 kg/m³; thickness: 4 mm.
PU foam density: 100 kg/m³; thickness: 4 mm.

The results are listed in Table 3.

TABLE 3

| | Stitch-tear strength (N/mm) |
|---|---|
| Ex 1-1 | 15 |
| Ex 2-1 | 7 |
| Ex 3-1 | 10 |
| CEx 2 (PU foam) | 1.2 |
| CEx 3 (EVA foam) | 0.8 |

1: A strobel for an article of footwear, the strobel comprising:
an expanded thermoplastic polyurethane (ETPU).

2: The strobel according to claim 1, wherein the strobel comprises a hybrid material of ETPU and a polyurethane (PU) foam matrix.

3: The strobel according to claim 1, wherein the strobel has a density of 50-500 kg/m³.

4: The strobel according to claim 1, wherein the strobel has a hardness of 25-50 AskerC, measured according to JIS K 7312.

5: The strobel according to claim 1, wherein the strobel has a rebound resilience of 50-80%, measured according to DIN 53 512:2000.

6: The strobel according to claim 1, wherein the ETPU has an average particle size of from 1 mm to 12 mm.

7: The strobel according to claim 2, wherein the PU foam matrix has a density of 50-600 kg/m³.

8: The strobel according to claim 2, wherein the hybrid material has a density of 50-600 kg/m³.

9: The strobel according to claim 2, wherein the hybrid material has a hardness of 25-50 AskerC, measured according to JTS K 7312.

10: The strobel according to claim 2, wherein the hybrid material has a rebound resilience of 30-80%, measured according to DIN 53 512:2000.

11: The strobel according to claim 2, wherein the strobel is produced by mixing
(a) polyisocyanates, with
(b) compounds having hydrogen atoms which are reactive toward isocyanates,
(c) ETPU particles and,
if appropriate,
(d) chain extenders and/or crosslinkers,
(e) catalysts,
blowing agents, and
(g) further additives;
to obtain a mixture, and
reacting the mixture in a mold to firm the strobel comprising the hybrid material.

12: The strobel according to claim 11, wherein component (b) is selected from the group consisting of polyether polyol, polyester polyol, and mixtures thereof.

13: The strobel according to claim 11, wherein component (b) is water.

14: The strobel according to claim 12, wherein the ETPU is present in an amount of 0.1-99 wt. %, based on a total weight of the hybrid material.

15: The strobel according to claim 13, wherein the ETPU is present in an amount of 0.1-99 wt. %, based on a total weight of the hybrid material.

16: An article of footwear, comprising the strobel as defined in claim 1.

17: The article of footwear according to claim 16, wherein the article of footwear comprises:
(a) the strobel;
(h) an upper bottomed with the strobel; and
(c) an outsole disposed below the strobel.

18: A process of manufacturing an article of footwear, the process comprising:
i) stitching an upper to the strobel as defined in claim 1; and/or
ii) hot-pressing the strobel as defined in claim 1 to an outsole.

19: The process as defined in claim 18, wherein i) comprises
i-1) processing the strobel to form a relatively thin periphery and stitching the upper to the strobel at the thin periphery, or
i-2) slotting the periphery of the strobel and stitching the strobel to the upper at the slotted periphery.

20: The process as defined in claim 18, wherein the outsole is made of ethylene vinyl acetate (EVA), PU, or suitable rubbers.
